(19) United States
(12) Patent Application Publication
(10) Pub. No.: US 2026/0169723 A1
(43) Pub. Date: Jun. 18, 2026

(54) Automated Identification and Power Consumption Optimization of Internet of Things Devices

(71) Applicant: International Business Machines Corporation, Armonk, NY (US)

(72) Inventors: Jeremy R. Fox, Georgetown, TX (US); Martin G. Keen, Cary, NC (US); Alexander Reznicek, Troy, NY (US); Bahman Hekmatshoartabari, White Plains, NY (US)

(21) Appl. No.: 18/985,725

(22) Filed: Dec. 18, 2024

(51) Int. Cl. G06F 8/65

(52) U.S. Cl. CPC G06F 8/65

(57) ABSTRACT

Power consumption optimization of IoT devices is provided. A device upgrade plan is generated outlining a sequence of actions for AI chip upgrade of a number of IoT devices based on assessment of hardware and software specification information corresponding to the number of IoT devices against requirements for the AI chip upgrade. A set of AI chip configurations is run in a simulation environment based on operational parameters corresponding to the number of IoT devices to identify a best AI chip configuration that delivers a lowest power consumption for the number of IoT devices while meeting defined performance benchmarks. At least one of a set of firmware updates, a set of driver software, and a set of configuration settings is transmitted to one or more of the number of IoT devices for the AI chip upgrade in accordance with the device upgrade plan based on the best AI chip configuration.

### BACKGROUND

The disclosure relates generally to internet of things and more specifically to managing power consumption of Internet of Things devices.

The Internet of Things (IOT) refers to devices, such as smart thermostats, smart vehicles, smart appliances, smartwatches, RFID-enabled clothing, and other physical objects, that are embedded with sensors, processing ability, software, network connectivity, and other technologies allowing these IoT devices to collect and share data via a network (e.g., the Internet) or other communication network. These IoT devices can create a vast network of interconnected devices that can exchange data and perform various tasks autonomously, such as, for example, monitoring environmental conditions on farms, managing traffic patterns for smart vehicles, controlling machines and processes in factories, tracking inventory and shipments in warehouses, and the like. As a result, the potential applications of IoT devices are vast and varied. As the number of network-connected devices continues to grow, IoT is likely to play an increasingly important role in shaping our world by transforming the way that we live, work, and interact with each other.

### SUMMARY

According to one illustrative embodiment, a method is provided. A device upgrade plan is generated outlining a specific sequence of actions for Artificial Intelligence (AI) chip upgrade of each of a number of IoT devices based on assessment of hardware and software specification information corresponding to each of the number of IoT devices against requirements for the AI chip upgrade. A set of predefined AI chip configurations is run in a simulation environment based on operational parameters corresponding to each of the number of IoT devices to identify a best AI chip configuration of the set of predefined AI chip configurations that delivers a lowest predicted power consumption to increase power efficiency for each respective IoT device of the number of IoT devices while meeting defined performance benchmarks corresponding to each respective IoT device of the number of IoT devices. At least one of a set of firmware updates, a set of driver software, and a set of configuration settings is transmitted automatically to one or more of the number of IoT devices for the AI chip upgrade in accordance with the device upgrade plan based on the best AI chip configuration of the set of predefined AI chip configurations that delivers the lowest predicted power consumption identified for each respective IoT device of the number of IoT devices to form a set of AI chip upgraded IoT devices. According to other illustrative embodiments, a computer system and computer program product are provided.

### BRIEF DESCRIPTION OF THE DRAWINGS

FIG. 1 is a pictorial representation of a computing environment in which illustrative embodiments may be implemented;

FIG. 2 is a diagram illustrating an example of a power consumption optimization system in accordance with an illustrative embodiment; and

FIGS. 3A-3E are a flowchart illustrating a process for power consumption optimization of Internet of Things (IoT) devices via Artificial Intelligence (AI) chip upgrade in accordance with an illustrative embodiment.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc), or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

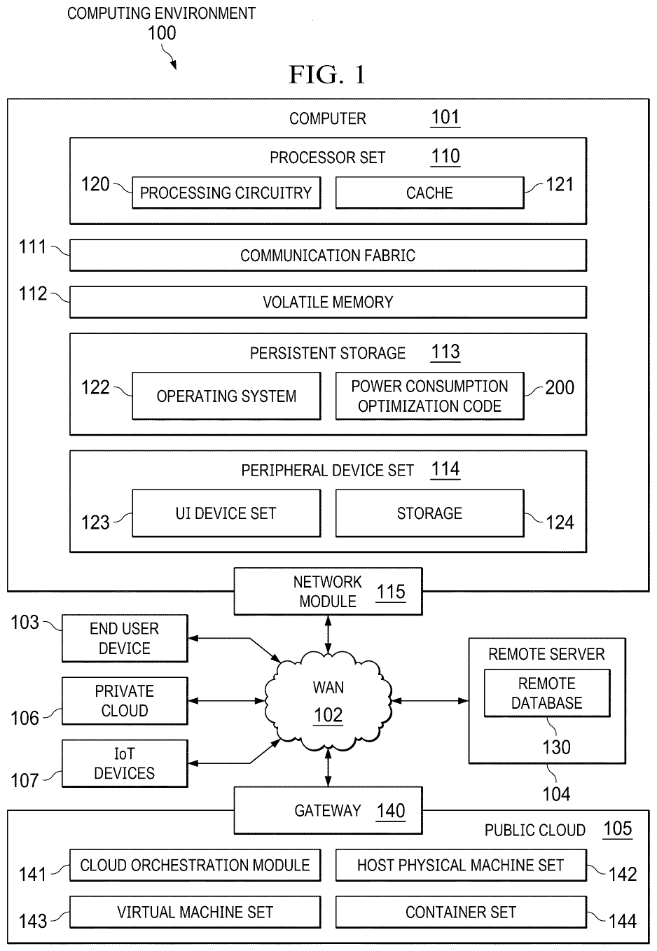

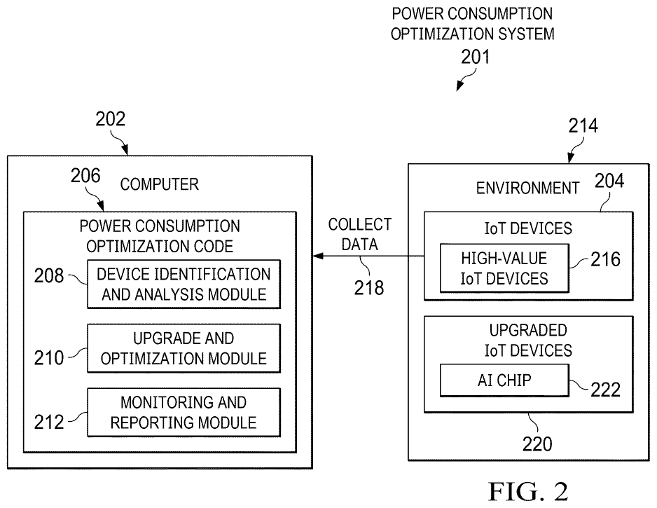

With reference now to the figures, and in particular, with reference to FIG. 1 and FIG. 2, diagrams of data processing environments are provided in which illustrative embodiments may be implemented. It should be appreciated that FIG. 1 and FIG. 2 are only meant as examples and are not intended to assert or imply any limitation with regard to the environments in which different embodiments may be implemented. Many modifications to the depicted environments may be made.

FIG. 1 shows a pictorial representation of a computing environment in which illustrative embodiments may be implemented. Computing environment 100 contains an example of an Internet of Things (IoT) environment for the execution of at least some of the computer code involved in performing the inventive methods of illustrative embodiments, such as power consumption optimization code 200. For example, power consumption optimization code 200 automatically identifies certain IoT devices located in the environment that will benefit from optimization of their power consumption via an artificial intelligence (AI) chip upgrade. AI chip upgrade can either be installation of a new AI chip on an IoT device or upgrading an existing AI chip on an IoT device. Upgrading an existing AI chip can include, for example, at least one of downloading new software, software patches, firmware updates, circuit modification, and the like.

In addition to power consumption optimization code 200, computing environment 100 includes, for example, computer 101, wide area network (WAN) 102, end user device (EUD) 103, remote server 104, public cloud 105, private cloud 106, and IoT devices 107. In this embodiment, computer 101 includes processor set 110 (including processing circuitry 120 and cache 121), communication fabric 111, volatile memory 112, persistent storage 113 (including operating system 122 and power consumption optimization code 200, as identified above), peripheral device set 114 (including user interface (UI) device set 123 and storage 124), and network module 115. Remote server 104 includes remote database 130. Public cloud 105 includes gateway 140, cloud orchestration module 141, host physical machine set 142, virtual machine set 143, and container set 144.

IoT devices 107 represent a plurality of different types of IoT devices located within computing environment 100. IoT devices 107 include a plurality of different functionality and capabilities, including AI functionality and capabilities. AI functionality and capabilities are provided by an AI chip located on given IoT devices. IoT devices 107 also includes high-value IoT devices. High-value IoT devices are IoT devices that cost more than a minimum cost threshold level, such as 5 cents, 10 cents, or the like. In other words, high-value IoT devices are not merely inexpensive sensors or the like. In addition, high-value IoT devices are critical IoT devices that perform essential functions which these critical IoT devices cannot perform when there is a lack of power.

Computer 101 may take the form of a mainframe computer, quantum computer, desktop computer, laptop computer, tablet computer, or any other form of computer now known or to be developed in the future that is capable of, for example, running a program, accessing a network, and querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods of illustrative embodiments may be stored in power consumption optimization code 200 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports, and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data, and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks, and even connections made through wide area networks such as the internet. In various embodiments, UI device set 123 may include components such as a display screen, speaker, microphone, wearable devices (such as smart glasses and smart watches), keyboard, mouse, printer, touchpad, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (e.g., where computer 101 locally stores and manages a large database) then this storage may be provided by peripheral storage devices designed for storing very large amounts of data, such as a storage area network (SAN) that is shared by multiple, geographically distributed computers.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (e.g., embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (e.g., the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

EUD 103 is any computer system that is used and controlled by an end user (e.g., a system administrator who utilizes the IoT device power consumption optimization services provided by computer 101), and may take any of the forms discussed above in connection with computer 101. EUD 103 typically receives helpful and useful data from the operations of computer 101. For example, in a hypothetical case where computer 101 is designed to provide IoT device AI chip upgrade recommendations to the end user, these recommendations would typically be communicated from network module 115 of computer 101 through WAN 102 to EUD 103. In this way, EUD 103 can display, or otherwise present, the recommendations to the end user. In some embodiments, EUD 103 may be a client device, such as a thin client, heavy client, mainframe computer, desktop computer, laptop computer, tablet computer, smart phone, and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to further train machine learning models based on aggregated historical data, then this aggregated historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single entity. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Public cloud 105 and private cloud 106 are programmed and configured to deliver cloud computing services and/or microservices (not separately shown in FIG. 1). Unless otherwise indicated, the word “microservices” shall be interpreted as inclusive of larger “services” regardless of size. Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of application programming interfaces (APIs). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (Saas) where software is centrally hosted and allocated on a subscription basis. SaaS is also known as on-demand software, web-based software, or web-hosted software. Four technological sub-fields involved in cloud services are: deployment, integration, on demand, and virtual private networks.

As used herein, when used with reference to items, “a set of” means one or more of the items. For example, a set of clouds is one or more different types of cloud environments. Similarly, “a number of,” when used with reference to items, means one or more of the items. Moreover, “a group of” or “a plurality of” when used with reference to items, means two or more of the items.

Further, the term “at least one of,” when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item B. This example may also include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

Innovations in AI chips (e.g., IBM NorthPole™ AI chips) align with a growing need for more efficient, low-power computing solutions, especially in the context of IoT devices that are increasingly becoming ubiquitous in various industries. AI chip design focuses on enhancing the power efficiency of AI computations, which is a factor in the deployment of AI in energy-sensitive environments.

Traditional digital computing solutions consume significant power, making these traditional digital computing solutions less ideal for IoT devices where energy consumption efficiency is a priority. In contrast, AI chips introduce a new paradigm in computing, optimizing energy consumption for performing AI tasks.

The proliferation of IoT devices in various environments, such as, for example, healthcare, manufacturing, smart cities, and the like, has escalated the need for energy-efficient AI computing solutions. AI chips offer a solution that can be integrated into IoT devices to enhance performance of these IoT devices without compromising power consumption or functionality.

In addition, as networks of IoT devices grow in complexity, the demand for scalable and high-performing AI chip solutions will also increase. AI chips can provide a scalable solution for AI computations, ensuring high performance even as a network of IoT devices expands.

However, IoT devices often face challenges related to energy consumption and efficiency. The integration of AI chips into IoT devices, while beneficial for enhancing the capabilities of IoT devices, has traditionally led to increased power usage, posing a significant problem in environments where energy resources are limited and/or costly. This is particularly true for high-value IoT devices that perform critical or essential functions or services, which cannot afford frequent lack of adequate power or reduced operational efficiency.

In addition, identifying these high-value IoT devices for power usage optimization remains a challenge. The vast and varied landscape of IoT devices, each with different functionalities, power requirements, and operational contexts, makes it difficult to effectively identify and upgrade certain IoT devices that would benefit from improved power consumption efficiency. Without an effective solution to identify and prioritize these IoT devices for upgrade, efforts to enhance their energy efficiency may be misdirected, leading to suboptimal utilization of resources and missed opportunities in power savings.

Moreover, it should be noted that the actual power consumption is not just dependent on the IoT device hardware, but also dependent on the type of AI task (e.g., compute bound workload, memory bound workload, or the like) running on a particular IoT device, the input data used for that particular type of AI task (e.g., dense input data or sparse input data), and the pattern of use (e.g., how frequently is the IoT device used and for how long). As a result, identifying the power consumption bottlenecks among a plurality of different IoT devices in a specific environment or use case is a non-trivial task.

Illustrative embodiments utilize a set of machine learning models (e.g., AI algorithms) to identify and prioritize certain IoT devices that will benefit from being upgraded with a low-power AI chip, which may be digital, analog, or a combination of both (i.e., mixed signal) depending on specific environment or use case. It should be noted that illustrative embodiments can utilize any generic low-power AI chip.

Illustrative embodiments take into account and address the challenge of excessive energy consumption in high-value IoT devices, especially those high-value IoT devices enhanced with AI functionality and capabilities. By identifying and upgrading those high-value IoT devices enhanced with AI functionality with an AI chip, illustrative embodiments can increase power consumption efficiency of those high-value IoT devices performing different types of AI-based tasks in various operational environments.

For example, illustrative embodiments utilize a set of machine learning models to identify those high-value IoT devices suitable for upgrade or conversion to AI chips in a particular environment. In addition, illustrative embodiments generate a customized power-saving AI chip solution for each identified high-value IoT device, considering the specific operational context and power requirements of that particular high-value IoT device. Further, illustrative embodiments adapt to different IoT device environments and scale to accommodate a change in the number of IoT devices in a particular IoT device environment.

In an illustrative example use case, a user specializes in integrating IoT technologies into smart homes. The user frequently encounters high-value IoT devices, such as, for example, smart thermostats, smart cameras, smart lighting systems, smart locking systems, and the like, in smart homes that consume large amounts of power, especially in AI-driven security systems. The user can utilize illustrative embodiments to identify and upgrade these high-value IoT devices with an AI chip, enhancing the power consumption efficiency of these high-value IoT devices without compromising AI functionality and capabilities of these high-value IoT devices. Thus, these energy-efficient AI chips can reduce the power consumption of their corresponding IoT devices, making these IoT devices more appealing to energy-conscious consumers.

In another illustrative example use case, a remote healthcare environment includes emergency medical IoT devices that often struggle with power constraints. The remote healthcare environment can utilize illustrative embodiments to identify and upgrade these emergency medical IoT devices, ensuring that these emergency medical IoT devices function optimally with limited power resources. For example, medical IoT devices, such as monitoring equipment and wearable health technology, can use the power usage optimization provided by AI chip solutions of illustrative embodiments to extend battery life and reliability, which are needed in healthcare settings. As a result, illustrative embodiments can improve healthcare delivery in a remote environment with power constraints.

In yet another illustrative example use case, a manufacturing plant includes a plurality of IoT sensors and devices. The manufacturing plant can utilize illustrative embodiments to identify high-value IoT devices in the manufacturing plant and upgrade these high-value IoT devices with AI chips to be more power-efficient, resulting in decreased operational costs and increased sustainability. In addition, the manufacturing plant can utilize the AI chip solutions of illustrative embodiments for industrial automation to optimize the power usage of its IoT sensors and data processing units, which are essential in large-scale industrial environments, for energy-savings.

In yet another illustrative example use case, automotive manufacturers, which are integrating more IoT device technology into their vehicles for enhanced connectivity and data gathering, can adopt the energy-saving AI chip solutions of illustrative embodiments to improve the efficiency of their onboard IoT systems. In yet another illustrative example use case, retailers, which use IoT devices for inventory management and logistics, can apply the energy-saving AI chip solutions of illustrative embodiments to enhance the energy efficiency of their vast array of IoT devices, from RFID readers to smart shelves.

Illustrative embodiments receive input data that include the operational context and power consumption of IoT devices within an environment, along with information regarding specific AI tasks performed by the IoT devices, amount of usage of each respective IoT device, and specification details of each respective IoT device for compatibility with and integration of an AI chip. Based on illustrative embodiments analyzing the input data using the set of machine learning models, illustrative embodiments output a list of high-value IoT devices prioritized for power consumption optimization, along with a customized power-saving AI chip solution for each respective high-value IoT device in the environment, a report on expected and actual power savings post-upgrade for each respective high-value IoT device, and operational efficiency and sustainability metrics for each upgraded high-value IoT device.

Illustrative embodiments utilize three components. One component is a device identification and analysis module. A second component is an upgrade and optimization module. A third component is a monitoring and reporting module.

The device identification and analysis module utilizes a number of supervised and unsupervised machine learning models to analyze incoming data retrieved from IoT devices located within a particular environment. The device identification and analysis module processes the incoming data, such as, for example, operational contexts, energy usage patterns, details of performed AI tasks, and the like, to identify one or more high-value IoT devices that are candidates for power consumption optimization. For example, the device identification and analysis module may use one or more clustering algorithms to group IoT devices based on power consumption patterns and one or more decision trees to determine the potential impact of power consumption optimization in a group of IoT devices. After analyzing the input data, illustrative embodiments output a profile of each identified high-value IoT device, including suitability of each identified IoT device for AI chip upgrade or integration with an AI chip. This profile output for each identified high-value IoT device guides the upgrade and optimization module in generating a customized power-saving AI chip solution for each identified high-value IoT device.

The upgrade and optimization module receives as input a detailed profile of each identified high-value IoT device from the identification and analysis module to orchestrate the upgrade or integration of an AI chip in a selected set of IoT devices within the environment. The upgrade and optimization module generates the customized upgrade plan for each selected high-value IoT device, considering factors, such as, for example, compatibility with an AI chip, operational context, specific set of AI tasks performed by a particular IoT device, and the like. Further, after AI chip upgrade or integration in a particular IoT device, the upgrade and optimization module sends performance data to the monitoring and reporting module for impact assessment of that particular IoT device.

The monitoring and reporting module utilizes real-time analytics to monitor the power consumption and overall power consumption efficiency of each upgraded high-value IoT device. The monitoring and reporting module utilizes predictive analytics to forecast future power consumption and operational efficiency of each upgraded high-value IoT device and generates reports regarding energy savings and sustainability improvements. Furthermore, the monitoring and reporting module provides feedback to both the device identification and analysis module and the upgrade and optimization module. The device identification and analysis module and the upgrade and optimization module utilize the feedback to continuously improve the accuracy of the machine leaning models for identifying certain IoT devices for AI chip upgrade and generating IoT device AI chip upgrade plans.

Thus, illustrative embodiments increase the power consumption efficiency of select IoT devices, thereby reducing operational costs and improving the sustainability of these select IoT devices. Accordingly, illustrative embodiments provide one or more technical solutions that overcome a technical problem with managing power consumption of IoT devices. As a result, these one or more technical solutions provide a technical effect and practical application in the field of IoT.

With reference now to FIG. 2, a diagram illustrating an example of a power consumption optimization system is depicted in accordance with an illustrative embodiment. Power consumption optimization system 201 may be implemented in a computing environment, such as computing environment 100 in FIG. 1. Power consumption optimization system 201 is a system of hardware and software components for identifying certain IoT devices for power consumption optimization via AI chip upgrade.

In this example, power consumption optimization system 201 includes computer 202 and IoT devices 204. Computer 202 may be, for example, computer 101 in FIG. 1. IoT devices 204 may be, for example, IoT devices 107 in FIG. 1. However, it should be noted that power consumption optimization system 201 is intended as an example only and not as a limitation on illustrative embodiments. For example, power consumption optimization system 201 can include any number of computers, sets of IoT devices, and other devices and components not shown.

Computer 202 includes power consumption optimization code 206, such as power consumption optimization code 200 in FIG. 1. In this example, power consumption optimization code 206 includes device identification and analysis module 208, upgrade and optimization module 210, and monitoring and reporting module 212. However, it should be noted that power consumption optimization code 206 is intended as an example only and can include any number of modules. For example, power consumption optimization code 206 can combine two modules into one, divide one module into two, remove a module, add a module not shown, or the like.

IoT devices 204 are located in environment 214. Environment 214 may be, for example, a manufacturing environment, retail environment, healthcare environment, educational environment, agricultural environment, industrial environment, business environment, or any other type of environment where IoT devices are located and functioning. In addition, IoT devices 204 include high-value IoT devices 216. High-value IoT devices 216 include essential functionality, such as AI functionality, for performing essential or critical tasks within environment 214.

Device identification and analysis module 208 includes a plurality of process steps. For example, device identification and analysis module 208 includes a data collection and preprocessing step. The data collection and preprocessing step begins at 218 by collecting data from each respective IoT device of IoT devices 204, which include high-value IoT devices 216, located in environment 214. The collected data include, for example, operational parameters, power consumption patterns, detailed of performed tasks such as AI tasks, and the like. The data collection and preprocessing step can utilize, for example, RESTful APIs for data ingestion from IoT devices 204. In addition, the data collection and preprocessing step complies with data privacy standards, such as, for example, the General Data Protection Regulation, for data handling. Then, the data collection and preprocessing step preprocesses the collected data to increase data quality and consistency. For example, the preprocessing of the collected data includes noise reduction, normalization, managing missing values, and the like.

Device identification and analysis module 208 also includes a feature extraction step. The feature extraction step involves identifying relevant features in the preprocessed data and then extracting the relevant features. For example, the feature extraction step identifies key features, attributes, or characteristics of IoT devices 204 that most influence power consumption and operational efficiency of a given IoT device. The feature extraction step can utilize techniques, such as, for example, Principal Component Analysis, a SelectKBest function, or the like for selecting features to reduce feature dimensionality and focus on the most relevant features for analysis.

Device identification and analysis module 208 further includes a model training step. Device identification and analysis module 208 uses supervised learning models, such as, for example, Random Forest, Gradient Boosting, and the like, to predict which of IoT devices 204 would benefit from power consumption optimization. Device identification and analysis module 208 trains the supervised learning models using historical data to understand power consumption patterns and correlations between features of IoT devices 204 and their power consumption efficiency. Device identification and analysis module 208 also uses unsupervised K-means clustering to segment IoT devices 204 into groups, such as high-value IoT devices 216, based on similar features.

Device identification and analysis module 208 further includes a model evaluation and optimization step. Device identification and analysis module 208 evaluates the machine learning models using metrics, such as, for example, accuracy, precision, recall, F1-score, and the like. Device identification and analysis module 208 continuously optimizes the machine learning models based on feedback received from monitoring and reporting module 212 regarding real time performance of upgraded IoT devices 220. Upgraded IoT devices 220 represent upgrades of certain IoT devices, such as high-value IoT devices 216, in IoT devices 204 via AI chip 222. AI chip 222 represents an upgrade of an existing AI chip on a given IoT device or installation of a new AI chip on a given IoT device.

Device identification and analysis module 208 further includes an output step for those certain IoT devices that would benefit from power consumption optimization. For example, device identification and analysis module 208 outputs a list of identified IoT devices prioritized for power consumption optimization, along with a confidence score indicating the potential impact of power consumption optimization on each of the identified IoT devices in the list. Device identification and analysis module 208 prioritizes or ranks the identified IoT devices for power consumption optimization based on the corresponding confidence score of each respective identified IoT device in the list. Device identification and analysis module 208 also outputs a profile of each identified IoT device in the list that includes suitability of each identified IoT device for AI chip upgrade or integration.

Upgrade and optimization module 210 also includes a plurality of process steps. For example, upgrade and optimization module 210 includes an upgrade plan development step. The upgrade plan development step utilizes a device compatibility analysis script that assesses the hardware and software specifications of each identified IoT device in the list provided by device identification and analysis module 208. The hardware and software specifications are provided in the profile generated by device identification and analysis module 208 for each respective identified IoT device in the list, against requirements for AI chip upgrade. For hardware, the device compatibility analysis script checks for physical space, power supply characteristics, and interfacing ports. For software, the device compatibility analysis script assesses the operating system, available drivers, and communication protocols. Upgrade and optimization module 210 can utilize, for example, a device compatibility analysis API to automate the assessment of IoT device compatibility with any generic AI chip. Then, the device compatibility analysis script generates a device upgrade plan, which outlines specific technical actions, such as circuit modifications, driver installations, software updates, and the like, and sequences these specific technical actions into an executable upgrade plan.

Upgrade and optimization module 210 also includes a step for customization of power-saving AI chip solutions. For example, upgrade and optimization module 210 runs through a predefined set of AI chip configurations in a simulation environment utilizing the operational parameters of each identified IoT device in the list. Upgrade and optimization module 210 evaluates each respective AI chip configuration in the predefined set of AI chip configurations using a power efficiency simulation model, which predicts the power usage of that particular IoT device for performing typical AI tasks. The power efficiency simulation model iterates through the predefined set of AI chip configurations until the power efficiency simulation model finds an optimized AI chip solution that delivers the lowest predicted power usage while meeting performance benchmarks for each identified IoT device. The power efficiency simulation model can utilize, for example, a genetic algorithm-based configuration selector to iteratively test and select the AI chip configuration having the best power consumption efficiency in the simulation environment.

Upgrade and optimization module 210 further includes an upgrade process execution step. For software, an over-the-air deployment manager script transmits, for example, firmware updates, driver software, configuration settings, and the like to a particular IoT device in the list for AI chip upgrade. For hardware, technicians utilize an integration procedure protocol, which provides step-by-step instructions derived from the device upgrade plan that includes, for example, safety checks, physical AI chip insertion, connection verification, and the like, which are all logged for quality assurance.

Upgrade and optimization module 210 further includes a post-upgrade testing and calibration step. The post-upgrade testing and calibration step utilizes a suite of diagnostic tools to automatically run a series of functional tests, stress tests, and performance tests on each of upgraded IoT devices 220. This suite of diagnostic tools reports on key performance indicators, such as, for example, energy consumption, computation latency, AI inference accuracy, and the like. If one or more key performance indicators fall below corresponding predefined minimum performance thresholds, then the upgrade and optimization module triggers a calibration adjustment tool, which runs a series of automated adjustments to the firmware settings of AI chip 222 and re-tests upgraded IoT devices 220 until the key performance indicators are greater than the corresponding predefined minimum performance thresholds. The calibration adjustment tool can utilize, for example, calibration adjustment algorithms to dynamically fine-tune the operational parameters of AI chip 222 for optimal performance post-upgrade.

Monitoring and reporting module 212 also includes a plurality of process steps. For example, monitoring and reporting module 212 includes an initial baseline assessment step. Monitoring and reporting module 212 begins with a baseline assessment tool that establishes baseline performance metrics for each of upgraded IoT devices 220. The baseline assessment tool records power consumption, operational efficiency, and AI task accuracy of each of upgraded IoT device 220. Monitoring and reporting module 212 utilizes these recorded baselines for comparative analysis post-upgrade.

Monitoring and reporting module 212 also includes a real time performance monitoring step. For example, after AI chip 222 upgrade of upgraded IoT devices 220 is complete, monitoring and reporting module 212 uses one or more sensors and monitoring agents located in upgraded IoT devices 220 to track real time power consumption, processing speed, and AI chip inference accuracy of each of upgraded IoT devices 220. Monitoring and reporting module 212 can utilize, for example, a performance data collection API to facilitate the collection of the real time performance data from upgraded IoT devices 220.

Monitoring and reporting module 212 also includes a data aggregation and analysis step. Monitoring and reporting module 212 sends the collected real time performance data to a knowledge corpus or central performance data warehouse, where the collected data is aggregated and analyzed. Deviations or anomalies from expected performance metrics trigger alerts. Monitoring and reporting module 212 can utilize, for example, one or more anomaly detection algorithms to monitor for deviations from the expected performance metrics to trigger the alerts. The knowledge corpus or central performance data warehouse uses time-series analysis to track performance trends and predict potential issues indicated by identified deviations before the potential issues become problems. The knowledge corpus or central performance data warehouse can utilize, for example, one or more time-series analysis algorithms to identify trends and predict future performance issues based on deviations from the expected performance metrics.

Monitoring and reporting module 212 also includes a reporting and visualization step. For example, monitoring and reporting module 212 utilizes a reporting engine to automatically generate customized reports for various stakeholders. The customized reports include interactive dashboards that visualize key performance indicators, providing insights into improvements in performance, power savings, and overall power consumption efficiency of upgraded IoT devices 220. The reporting engine can utilize, for example, a visualization and reporting API to generate the customized reports with interactive dashboards.

Monitoring and reporting module 212 also includes a feedback step for machine learning model optimization. Monitoring and reporting module 212 derives insights from a feed received from the knowledge corpus or performance data warehouse and inputs the derived insights into an optimization feedback system, which identifies potential areas for further improvement regarding power consumption efficiency of upgraded IoT devices 220. The optimization feedback system generates recommendations for device identification and analysis module 208 and upgrade and optimization module 210, thus closing the feedback loop.

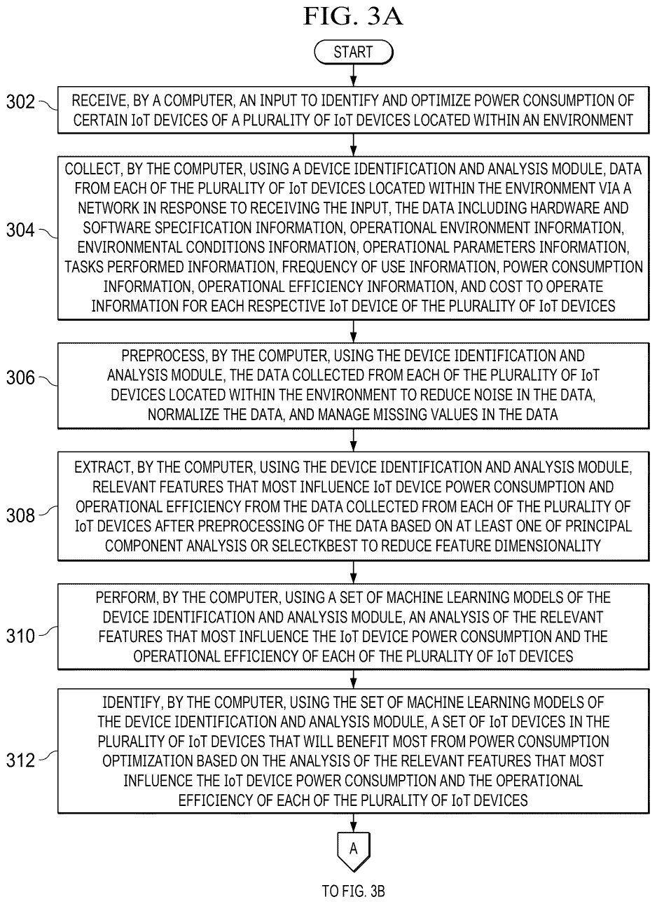

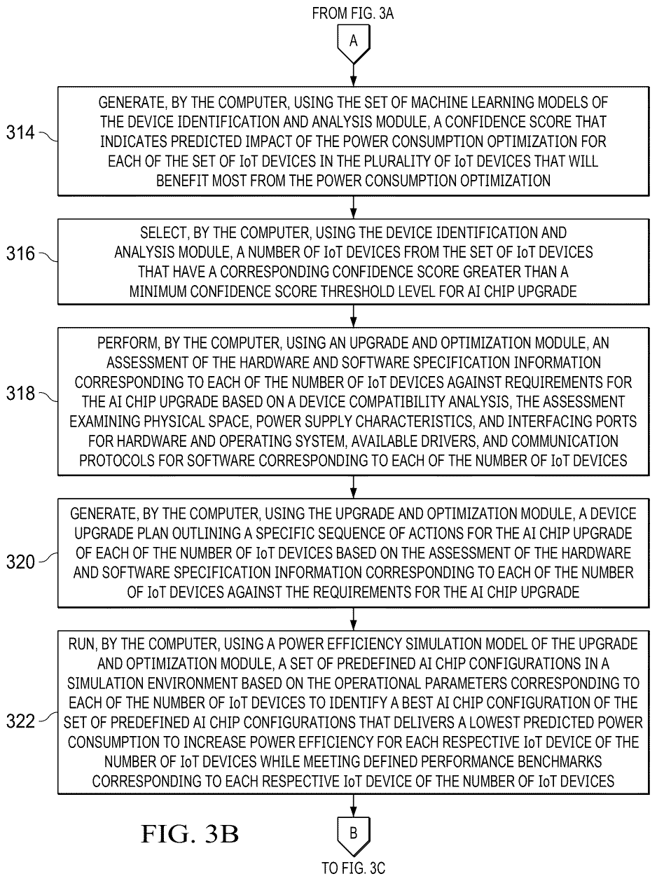

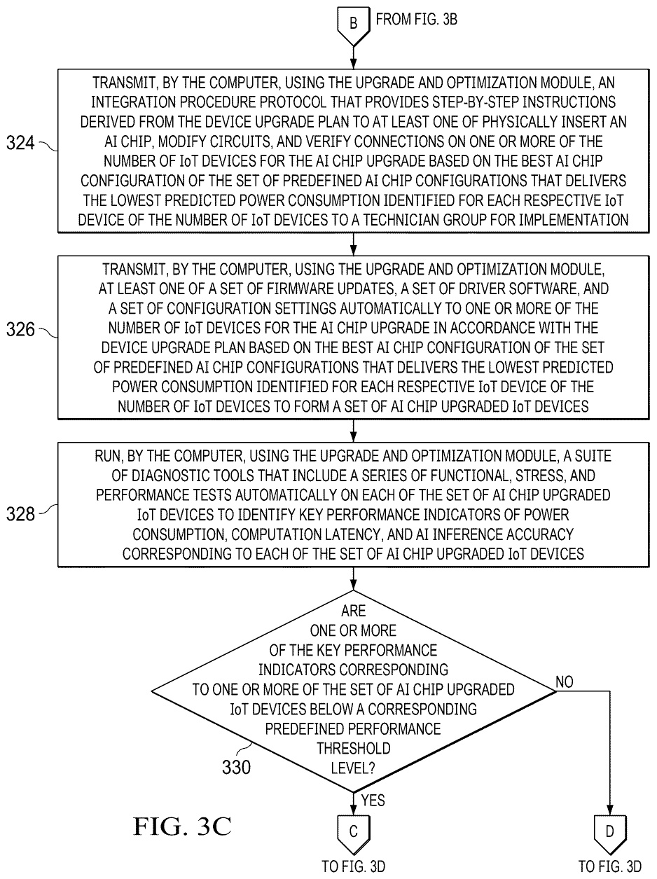

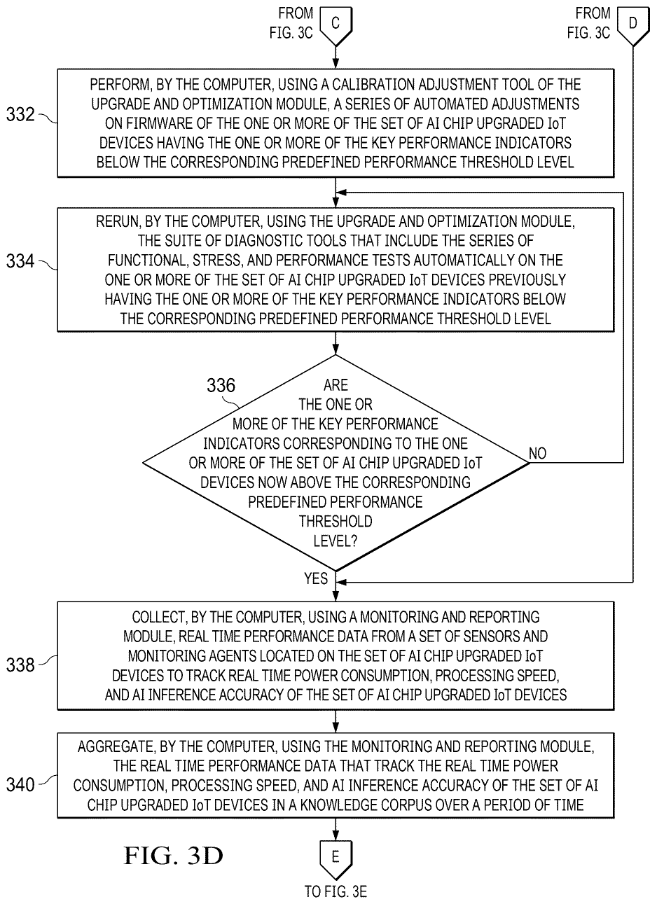

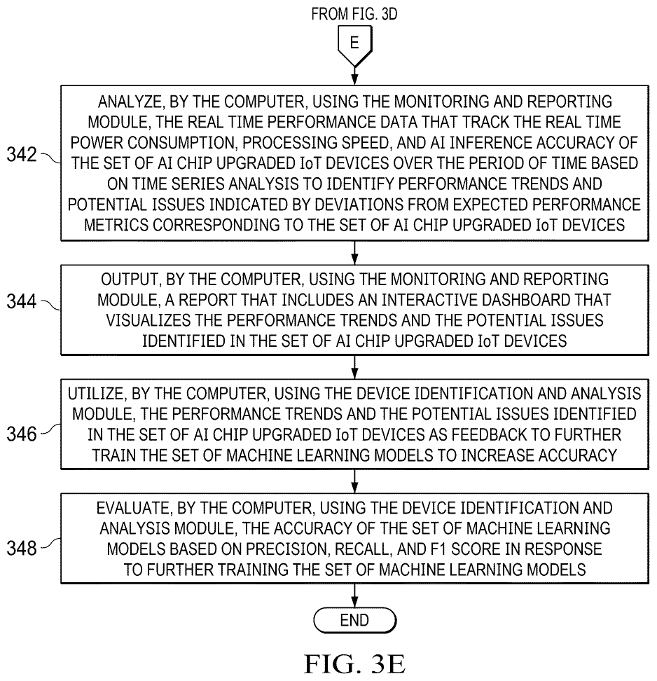

With reference now to FIGS. 3A-3E, a flowchart illustrating a process for power consumption optimization of IoT devices via AI chip upgrade is shown in accordance with an illustrative embodiment. The process shown in FIGS. 3A-3E may be implemented in a computer, such as, for example, computer 101 in FIG. 1 or computer 202 in FIG. 2. For example, the process shown in FIGS. 3A-3E may be implemented by power consumption optimization code 200 in FIG. 1 or power consumption optimization code 206 in FIG. 2.

The process begins when the computer receives an input to identify and optimize power consumption of certain IoT devices of a plurality of IoT devices located within an environment (step 302). The environment may be, for example, a business environment, retail environment, manufacturing environment, farming environment, healthcare environment, industrial environment, smart home environment, or any other type of environment.

The computer, using a device identification and analysis module, collects data from each of the plurality of IoT devices located within the environment via a network in response to receiving the input (step 304). The data include hardware and software specification information, operational environment information, environmental conditions information, operational parameters information, tasks performed information, frequency of use information, power consumption information, operational efficiency information, and cost to operate information for each respective IoT device of the plurality of IoT devices.

The computer, using the device identification and analysis module, preprocesses the data collected from each of the plurality of IoT devices located within the environment to reduce noise in the data, normalize the data, and manage missing values in the data (step 306). The computer, using the device identification and analysis module, extracts relevant features that most influence IoT device power consumption and operational efficiency from the data collected from each of the plurality of IoT devices after preprocessing of the data based on at least one of principal component analysis or SelectKBest to reduce feature dimensionality (step 308).

The computer, using a set of machine learning models of the device identification and analysis module, performs an analysis of the relevant features that most influence the IoT device power consumption and the operational efficiency of each of the plurality of IoT devices (step 310). The computer, using the set of machine learning models of the device identification and analysis module, identifies a set of IoT devices in the plurality of IoT devices that will benefit most from power consumption optimization based on the analysis of the relevant features that most influence the IoT device power consumption and the operational efficiency of each of the plurality of IoT devices (step 312).

In addition, the computer, using the set of machine learning models of the device identification and analysis module, generates a confidence score that indicates predicted impact of the power consumption optimization for each of the set of IoT devices in the plurality of IoT devices that will benefit most from the power consumption optimization (step 314). Further, the computer, using the device identification and analysis module, selects a number of IoT devices from the set of IoT devices that have a corresponding confidence score greater than a minimum confidence score threshold level for AI chip upgrade (step 316).

Furthermore, the computer, using an upgrade and optimization module, performs an assessment of the hardware and software specification information corresponding to each of the number of IoT devices against requirements for the AI chip upgrade based on a device compatibility analysis (step 318). The assessment examines physical space, power supply characteristics, and interfacing ports for hardware and operating system, available drivers, and communication protocols for software corresponding to each of the number of IoT devices. The computer, using the upgrade and optimization module, generates a device upgrade plan outlining a specific sequence of actions for the AI chip upgrade of each of the number of IoT devices based on the assessment of the hardware and software specification information corresponding to each of the number of IoT devices against the requirements for the AI chip upgrade (step 320).

The computer, using a power efficiency simulation model of the upgrade and optimization module, runs a set of predefined AI chip configurations in a simulation environment based on the operational parameters corresponding to each of the number of IoT devices to identify a best AI chip configuration of the set of predefined AI chip configurations that delivers a lowest predicted power consumption to increase power efficiency for each respective IoT device of the number of IoT devices while meeting defined performance benchmarks corresponding to each respective IoT device of the number of IoT devices (step 322). The computer, using the upgrade and optimization module, transmits an integration procedure protocol that provides step-by-step instructions derived from the device upgrade plan to at least one of physically insert an AI chip, modify circuits, and verify connections on one or more of the number of IoT devices for the AI chip upgrade based on the best AI chip configuration of the set of predefined AI chip configurations that delivers the lowest predicted power consumption identified for each respective IoT device of the number of IoT devices to a technician group for implementation (step 324). The computer, using the upgrade and optimization module, also transmits at least one of a set of firmware updates, a set of driver software, and a set of configuration settings automatically to one or more of the number of IoT devices for the AI chip upgrade in accordance with the device upgrade plan based on the best AI chip configuration of the set of predefined AI chip configurations that delivers the lowest predicted power consumption identified for each respective IoT device of the number of IoT devices to form a set of AI chip upgraded IoT devices (step 326).

The computer, using the upgrade and optimization module, runs a suite of diagnostic tools that include a series of functional, stress, and performance tests automatically on each of the set of AI chip upgraded IoT devices to identify key performance indicators of power consumption, computation latency, and AI inference accuracy corresponding to each of the set of AI chip upgraded IoT devices (step 328). The computer, using the upgrade and optimization module, makes a determination as to whether one or more of the key performance indicators corresponding to one or more of the set of AI chip upgraded IoT devices are below a corresponding predefined performance threshold level (step 330). If the computer, using the upgrade and optimization module, determines that the key performance indicators corresponding to the set of AI chip upgraded IoT devices are not below the corresponding predefined performance threshold level, no output of step 330, then the process proceeds to step 338. If the computer, using the upgrade and optimization module, determines that one or more of the key performance indicators corresponding to one or more of the set of AI chip upgraded IoT devices are below the corresponding predefined performance threshold level, yes output of step 330, then the computer, using a calibration adjustment tool of the upgrade and optimization module, performs a series of automated adjustments on firmware of the one or more of the set of AI chip upgraded IoT devices having the one or more of the key performance indicators below the corresponding predefined performance threshold level (step 332).

Afterward, the computer, using the upgrade and optimization module, reruns the suite of diagnostic tools that include the series of functional, stress, and performance tests automatically on the one or more of the set of AI chip upgraded IoT devices previously having the one or more of the key performance indicators below the corresponding predefined performance threshold level (step 334). The computer, using the upgrade and optimization module, makes a determination as to whether the one or more of the key performance indicators corresponding to the one or more of the set of AI chip upgraded IoT devices are now above the corresponding predefined performance threshold level after rerunning the suite of diagnostic tools (step 336).

If the computer, using the upgrade and optimization module, determines that the one or more of the key performance indicators corresponding to the one or more of the set of AI chip upgraded IoT devices are still not above the corresponding predefined performance threshold level after rerunning the suite of diagnostic tools, no output of step 336, then the process returns to step 334 where the computer, using the upgrade and optimization module, again reruns the suite of diagnostic tools on the one or more of the set of AI chip upgraded IoT devices. If the computer, using the upgrade and optimization module, determines that the one or more of the key performance indicators corresponding to the one or more of the set of AI chip upgraded IoT devices are now above the corresponding predefined performance threshold level after rerunning the suite of diagnostic tools, yes output of step 336, then the computer, using a monitoring and reporting module, collects real time performance data from a set of sensors and monitoring agents located on the set of AI chip upgraded IoT devices to track real time power consumption, processing speed, and AI inference accuracy of the set of AI chip upgraded IoT devices (step 338).

Further, the computer, using the monitoring and reporting module, aggregates the real time performance data that track the real time power consumption, processing speed, and AI inference accuracy of the set of AI chip upgraded IoT devices in a knowledge corpus over a period of time (step 340). Subsequently, the computer, using the monitoring and reporting module, analyzes the real time performance data that track the real time power consumption, processing speed, and AI inference accuracy of the set of AI chip upgraded IoT devices over the period of time based on time series analysis to identify performance trends and potential issues indicated by deviations from expected performance metrics corresponding to the set of AI chip upgraded IoT devices (step 342).

The computer, using the monitoring and reporting module, outputs a report that includes an interactive dashboard that visualizes the performance trends and the potential issues identified in the set of AI chip upgraded IoT devices (step 344). In addition, the computer, using the device identification and analysis module, utilizes the performance trends and the potential issues identified in the set of AI chip upgraded IoT devices as feedback to further train the set of machine learning models to increase accuracy (step 346). Moreover, the computer, using the device identification and analysis module, evaluates the accuracy of the set of machine learning models based on precision, recall, and F1 score in response to further training the set of machine learning models (step 348). Thereafter, the process terminates.

Thus, illustrative embodiments of the present disclosure provide a computer-implemented method, computer system, and computer program product for power consumption optimization of IoT devices via AI chip upgrade. The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
generating a device upgrade plan outlining a specific sequence of actions for Artificial Intelligence (AI) chip upgrade of each of a number of IoT devices based on assessment of hardware and software specification information corresponding to each of the number of IoT devices against requirements for the AI chip upgrade;
running a set of predefined AI chip configurations in a simulation environment based on operational parameters corresponding to each of the number of IoT devices to identify a best AI chip configuration of the set of predefined AI chip configurations that delivers a lowest predicted power consumption to increase power efficiency for each respective IoT device of the number of IoT devices while meeting defined performance benchmarks corresponding to each respective IoT device of the number of IoT devices; and
transmitting at least one of a set of firmware updates, a set of driver software, and a set of configuration settings automatically to one or more of the number of IoT devices for the AI chip upgrade in accordance with the device upgrade plan based on the best AI chip configuration of the set of predefined AI chip configurations that delivers the lowest predicted power consumption identified for each respective IoT device of the number of IoT devices to form a set of AI chip upgraded IoT devices.

2. The method of claim 1, further comprising:
transmitting an integration procedure protocol that provides instructions derived from the device upgrade plan to at least one of physically insert an AI chip, modify circuits, and verify connections on one or more of the number of IoT devices for the AI chip upgrade based on the best AI chip configuration of the set of predefined AI chip configurations that delivers the lowest predicted power consumption identified for each respective IoT device of the number of IoT devices to a technician group for implementation.

3. The method of claim 1, further comprising:
running a suite of diagnostic tools automatically on each of the set of AI chip upgraded IoT devices to identify key performance indicators of power consumption, computation latency, and AI inference accuracy corresponding to each of the set of AI chip upgraded IoT devices;
determining whether one or more of the key performance indicators corresponding to one or more of the set of AI chip upgraded IoT devices are below a corresponding predefined performance threshold level; and
responsive to determining that one or more of the key performance indicators corresponding to one or more of the set of AI chip upgraded IoT devices are below the corresponding predefined performance threshold level, performing a series of automated adjustments on firmware of the one or more of the set of AI chip upgraded IoT devices having the one or more of the key performance indicators below the corresponding predefined performance threshold level.

4. The method of claim 1, further comprising:
collecting real time performance data from a set of sensors and monitoring agents located on the set of AI chip upgraded IoT devices to track real time power consumption, processing speed, and AI inference accuracy of the set of AI chip upgraded IoT devices;
aggregating the real time performance data that track the real time power consumption, processing speed, and AI inference accuracy of the set of AI chip upgraded IoT devices in a knowledge corpus over a period of time; and
analyzing the real time performance data that track the real time power consumption, processing speed, and AI inference accuracy of the set of AI chip upgraded IoT devices over the period of time based on time series analysis to identify performance trends and potential issues indicated by deviations from expected performance metrics corresponding to the set of AI chip upgraded IoT device.

5. The method of claim 4, further comprising:
utilizing the performance trends and the potential issues identified in the set of AI chip upgraded IoT devices as feedback to further train a set of machine learning models to increase accuracy; and
evaluating the accuracy of the set of machine learning models based on precision, recall, and F1 score in response to further training the set of machine learning models.

6. The method of claim 1, further comprising:
receiving an input to identify and optimize power consumption of certain IoT devices of a plurality of IoT devices located within an environment;
collecting data from each of the plurality of IoT devices located within the environment via a network in response to receiving the input; and
extracting relevant features that most influence IoT device power consumption and operational efficiency from the data collected from each of the plurality of IoT devices.

7. The method of claim 6, further comprising:
performing, using a set of machine learning models, an analysis of the relevant features that most influence the IoT device power consumption and the operational efficiency of each of the plurality of IoT devices; and
identifying, using the set of machine learning models, a set of IoT devices in the plurality of IoT devices that will benefit from power consumption optimization based on the analysis of the relevant features that most influence the IoT device power consumption and the operational efficiency of each of the plurality of IoT devices.

8. The method of claim 7, further comprising:
generating, using the set of machine learning models, a confidence score that indicates predicted impact of the power consumption optimization for each of the set of IoT devices in the plurality of IoT devices that will benefit from the power consumption optimization;
selecting the number of IoT devices from the set of IoT devices that have a corresponding confidence score greater than a minimum confidence score threshold level for the AI chip upgrade; and
performing the assessment of the hardware and software specification information corresponding to each of the number of IoT devices against requirements for the AI chip upgrade based on a device compatibility analysis.

9. A computer system comprising:
a processor set;
one or more computer-readable storage media; and
program instructions stored on the one or more computer-readable storage media to cause the processor set to perform operations comprising:
generating a device upgrade plan outlining a specific sequence of actions for Artificial Intelligence (AI) chip upgrade of each of a number of IoT devices based on assessment of hardware and software specification information corresponding to each of the number of IoT devices against requirements for the AI chip upgrade;
running a set of predefined AI chip configurations in a simulation environment based on operational parameters corresponding to each of the number of IoT devices to identify a best AI chip configuration of the set of predefined AI chip configurations that delivers a lowest predicted power consumption to increase power efficiency for each respective IoT device of the number of IoT devices while meeting defined performance benchmarks corresponding to each respective IoT device of the number of IoT devices; and
transmitting at least one of a set of firmware updates, a set of driver software, and a set of configuration settings automatically to one or more of the number of IoT devices for the AI chip upgrade in accordance with the device upgrade plan based on the best AI chip configuration of the set of predefined AI chip configurations that delivers the lowest predicted power consumption identified for each respective IoT device of the number of IoT devices to form a set of AI chip upgraded IoT devices.

10. The computer system of claim 9, wherein the operations further comprise:
transmitting an integration procedure protocol that provides instructions derived from the device upgrade plan to at least one of physically insert an AI chip, modify circuits, and verify connections on one or more of the number of IoT devices for the AI chip upgrade based on the best AI chip configuration of the set of predefined AI chip configurations that delivers the lowest predicted power consumption identified for each respective IoT device of the number of IoT devices to a technician group for implementation.

11. The computer system of claim 9, wherein the operations further comprise:
running a suite of diagnostic tools automatically on each of the set of AI chip upgraded IoT devices to identify key performance indicators of power consumption, computation latency, and AI inference accuracy corresponding to each of the set of AI chip upgraded IoT devices;
determining whether one or more of the key performance indicators corresponding to one or more of the set of AI chip upgraded IoT devices are below a corresponding predefined performance threshold level; and
responsive to determining that one or more of the key performance indicators corresponding to one or more of the set of AI chip upgraded IoT devices are below the corresponding predefined performance threshold level, performing a series of automated adjustments on firmware of the one or more of the set of AI chip upgraded IoT devices having the one or more of the key performance indicators below the corresponding predefined performance threshold level.

12. The computer system of claim 9, wherein the operations further comprise:
collecting real time performance data from a set of sensors and monitoring agents located on the set of AI chip upgraded IoT devices to track real time power consumption, processing speed, and AI inference accuracy of the set of AI chip upgraded IoT devices;
aggregating the real time performance data that track the real time power consumption, processing speed, and AI inference accuracy of the set of AI chip upgraded IoT devices in a knowledge corpus over a period of time; and
analyzing the real time performance data that track the real time power consumption, processing speed, and AI inference accuracy of the set of AI chip upgraded IoT devices over the period of time based on time series analysis to identify performance trends and potential issues indicated by deviations from expected performance metrics corresponding to the set of AI chip upgraded IoT device.

13. The computer system of claim 12, wherein the operations further comprise:
utilizing the performance trends and the potential issues identified in the set of AI chip upgraded IoT devices as feedback to further train a set of machine learning models to increase accuracy; and
evaluating the accuracy of the set of machine learning models based on precision, recall, and F1 score in response to further training the set of machine learning models.

14. A computer program product comprising:
one or more computer-readable storage media; and
program instructions stored on the one or more computer-readable storage media to perform operations comprising:
generating a device upgrade plan outlining a specific sequence of actions for Artificial Intelligence (AI) chip upgrade of each of a number of IoT devices based on assessment of hardware and software specification information corresponding to each of the number of IoT devices against requirements for the AI chip upgrade;
running a set of predefined AI chip configurations in a simulation environment based on operational parameters corresponding to each of the number of IoT devices to identify a best AI chip configuration of the set of predefined AI chip configurations that delivers a lowest predicted power consumption to increase power efficiency for each respective IoT device of the number of IoT devices while meeting defined performance benchmarks corresponding to each respective IoT device of the number of IoT devices; and
transmitting at least one of a set of firmware updates, a set of driver software, and a set of configuration settings automatically to one or more of the number of IoT devices for the AI chip upgrade in accordance with the device upgrade plan based on the best AI chip configuration of the set of predefined AI chip configurations that delivers the lowest predicted power consumption identified for each respective IoT device of the number of IoT devices to form a set of AI chip upgraded IoT devices.

15. The computer program product of claim 14, wherein the operations further comprise:
transmitting an integration procedure protocol that provides instructions derived from the device upgrade plan to at least one of physically insert an AI chip, modify circuits, and verify connections on one or more of the number of IoT devices for the AI chip upgrade based on the best AI chip configuration of the set of predefined AI chip configurations that delivers the lowest predicted power consumption identified for each respective IoT device of the number of IoT devices to a technician group for implementation.

16. The computer program product of claim 14, wherein the operations further comprise:
running a suite of diagnostic tools automatically on each of the set of AI chip upgraded IoT devices to identify key performance indicators of power consumption, computation latency, and AI inference accuracy corresponding to each of the set of AI chip upgraded IoT devices;
determining whether one or more of the key performance indicators corresponding to one or more of the set of AI chip upgraded IoT devices are below a corresponding predefined performance threshold level; and
responsive to determining that one or more of the key performance indicators corresponding to one or more of the set of AI chip upgraded IoT devices are below the corresponding predefined performance threshold level, performing a series of automated adjustments on firmware of the one or more of the set of AI chip upgraded IoT devices having the one or more of the key performance indicators below the corresponding predefined performance threshold level.

17. The computer program product of claim 14, wherein the operations further comprise:
collecting real time performance data from a set of sensors and monitoring agents located on the set of AI chip upgraded IoT devices to track real time power consumption, processing speed, and AI inference accuracy of the set of AI chip upgraded IoT devices;
aggregating the real time performance data that track the real time power consumption, processing speed, and AI inference accuracy of the set of AI chip upgraded IoT devices in a knowledge corpus over a period of time; and
analyzing the real time performance data that track the real time power consumption, processing speed, and AI inference accuracy of the set of AI chip upgraded IoT devices over the period of time based on time series analysis to identify performance trends and potential issues indicated by deviations from expected performance metrics corresponding to the set of AI chip upgraded IoT device.

18. The computer program product of claim 17, wherein the operations further comprise:
utilizing the performance trends and the potential issues identified in the set of AI chip upgraded IoT devices as feedback to further train a set of machine learning models to increase accuracy; and
evaluating the accuracy of the set of machine learning models based on precision, recall, and F1 score in response to further training the set of machine learning models.

19. The computer program product of claim 14, wherein the operations further comprise:
receiving an input to identify and optimize power consumption of certain IoT devices of a plurality of IoT devices located within an environment;
collecting data from each of the plurality of IoT devices located within the environment via a network in response to receiving the input; and
extracting relevant features that most influence IoT device power consumption and operational efficiency from the data collected from each of the plurality of IoT devices.

20. The computer program product of claim 19, wherein the operations further comprise:
performing, using a set of machine learning models, an analysis of the relevant features that most influence the IoT device power consumption and the operational efficiency of each of the plurality of IoT devices; and
identifying, using the set of machine learning models, a set of IoT devices in the plurality of IoT devices that will benefit from power consumption optimization based on the analysis of the relevant features that most influence the IoT device power consumption and the operational efficiency of each of the plurality of IoT devices.
